(19) United States
(12) Patent Application Publication
(10) Pub. No.: US 2019/0208048 A1
(43) Pub. Date: Jul. 4, 2019

(54) MOBILE TELEPHONE CASE WITH STORAGE FOR AUXILIARY CABLE

(71) Applicant: Joshua Butler, Calhoun, LA (US)

(72) Inventor: Joshua Butler, Calhoun, LA (US)

(21) Appl. No.: 16/238,387

(22) Filed: Jan. 2, 2019

Related U.S. Application Data
(60) Provisional application No. 62/612,882, filed on Jan. 2, 2018.

(51) Int. Cl. H04M 1/15; H04B 1/3888; H01R 13/60; A45C 11/00; A45C 13/02

(52) U.S. Cl. CPC H04M 1/15; H04B 1/3888; H01R 24/60; A45C 11/00; A45C 13/02; H01R 13/60

(57) ABSTRACT

A mobile telephone case is provided comprising a back surface including an indention configured to receive and hold an auxiliary cable. The indention is formed in the back surface such that the form of the indention is substantially similar to the shape of the auxiliary cord.

### CROSS-REFERENCE TO RELATED APPLICATION

This invention is related to and depends from U.S. Provisional Application No. 62/612,882, titled “Phone Case with Aux Storage,” filed Jan. 2, 2018, by the above name inventor.

### RELATED FILED

The present invention relates in general to mobile telephone cases and, specifically to a mobile telephone case capable of storing an auxiliary cable.

### BACKGROUND OF THE INVENTION

Mobile telephone cases are becoming increasingly popular because they provide protection and prevent a mobile phone from becoming scratched, dented, cracked, or otherwise damaged, which in turn devalues the phone. There are numerous types and designs for mobile phone cases that differ based on material, design, and cost. Many mobile phone cases either have a single case that forms to the mobile phone itself or includes two or more pieces that interconnect to provide a cover for the back and sides of the phone. Whether the mobile telephone case is a single case, or is constructed of multiple conjoined cases (or multiple case parts), both designs tend to leave the face of the phone open and freely accessible so that users can access the display, especially touch screen displays.

Generally, mobile telephone phone cases serve to encase and protect the mobile phone without providing room to carry mobile phone accessories. In some instances, the mobile telephone user may wish to use an auxiliary cable, such as when the user wishes to connect the mobile telephone to a third separate device. For example, when the user wishes to connect his mobile telephone to a set of headphones, the user may need an auxiliary cable adapter to complete the connection. If the auxiliary cable is not readily available, the user may not be able to connect the mobile telephone to the headphones.

Prior art attempts that seek to ensure that an auxiliary cable, or other needed accessory, is readily available to the user, are deficient in that they increase the size and/or complexity of the mobile telephone case. For example, U.S. Pat. No. 8,499,933 B2, titled “Compartmentalized protective case for Portable handheld electronic devices,” issued Aug. 6, 2013 to Ziemba and U.S. Patent Application No. 2013/0148839 A1 are typical of prior art attempts that teach a mobile telephone case with storage compartments. Further still, U.S. Patent Application No. 2011/0204407, titled “Cellular Phone Case and Storage Accessory”, issued Nov. 24, 2011 to Connolly teaches a multi-sectional mobile phone case include a lower section having a pocket of storing credit cards and a mirror. In both instances, the prior arts have moving parts that make up the storage area and increase the overall size and complexity of the mobile phone case.

In some instances, the auxiliary accessory may be fixed to the mobile telephone case, to ensure the accessory is available with the user desires to use it. For example, U.S. Pat. No. 8,579,172, titled “Case and covers for electronic handheld devices” issued Nov. 12, 2013 to Monaco, et all teaches a retractable bottle opener fixed to and stored in a mobile telephone case. Similarly, U.S. Patent Application No. 2013/0265702 A1, titled “Retractable Storage System for Handheld Electronic Devices,” issued Oct. 10, 2013 teaches a compartment with a removable panel and an accessory station for retracting and storing a cord. Consequently, prior arts with auxiliary accessories affixed to a mobile telephone case also add to the complexity and overall size of the mobile telephone case.

What is needed is a mobile telephone case that facilitates storage of the auxiliary cable that does not add significant complexity and size to device. A suitable mobile telephone case will be simpler to manufacture, and would be more convenient for the user to carry.

### SUMMARY OF THE INVENTION

The present invention provides a protective mobile telephone cover having a rear surface (called “second surface” herein) for storing an auxiliary cable therein. In still another aspect of the invention, the user may store an auxiliary cable in the rear surface of the mobile telephone case without the use of compartments having doors or moving parts. accordance with one aspect of the invention, the mobile telephone case rear surface includes a recess formed therein for removably receiving an auxiliary cable. In another aspect of the invention, the recess is configured to abut against the auxiliary cable on at least one side. In yet another aspect, the recess includes lateral grasping projections protruding across a top portion of the recess for removably affixing an auxiliary cable therein. In yet another aspect of the invention, the grasping projections protrude at least partially overhanging the recess.

In one embodiment, a case for a mobile terminal is disclosed comprising, a first surface having a thickness, wherein the first surface comprises, a top surface for receiving a mobile terminal thereon, a bottom surface positioned opposite the top surface, wherein the top surface is separated from the bottom surface by said thickness, wherein the bottom surface comprises a recess formed therein, wherein the recess is formed at a depth less than the thickness, and wherein the recess is configured to receive an auxiliary cable therein.

### BRIEF DESCRIPTION OF DRAWINGS

The accompanying drawings, which are incorporated in and constitute a part of this specification, illustrate exemplary and preferred embodiments of the invention, and together with the description, serve to explain the principles of the apparatus taught, herein.

FIG. 1 is a depiction of a mobile telephone case according to the present invention, in the environment in which it is used;

FIG. 2 is a frontal view of a depiction of the mobile telephone case according to exemplary embodiments of the present invention

FIG. 3 is a side view of the mobile telephone case according to exemplary embodiments of the present invention;

FIG. 4 depicts a back surface of the mobile telephone case according to an exemplary embodiment of the present invention, showing a preferred location for the auxiliary cable indention;

FIG. 5 depicts the back surface of the mobile telephone case according to an exemplary embodiment of the present invention, showing another preferred location for the auxiliary cable indention;

FIG. 6 depicts the back surface of the mobile telephone case according to an exemplary embodiment of the present invention, showing another preferred location for the auxiliary cable indention;

FIG. 7 depicts the auxiliary cable recess including grasping projections for removably holding the auxiliary cable;

FIG. 8 depicts an exemplary prior art auxiliary cable useful with the present invention; and

FIG. 9 is a depiction of an exemplary embodiment of the present invention showing the auxiliary cable being removably held in place.

### DETAILED DESCRIPTION OF A PREFERRED EMBODIMENT

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, steps, operations, elements, and/or components, but do not preclude the presence or addition of one or more other features, steps, operations, elements, components, and/or groups thereof.

Spatially relative terms, such as “beneath,” “below,” “lower,” “above,” “upper”, “front”, “rear”, “back”, and the like may be used to describe an element and/or feature's relationship to another element(s) and/or feature(s) as, for example, illustrated in the figures. It will be understood that the spatially relative terms are intended to encompass different orientations of the device in use and/or operation in addition to the orientation depicted in the figures. For example, if the device in the figures is turned over, elements described as “below” and/or “beneath” other elements or features would then be oriented “above” the other elements or features. The device may be otherwise oriented (e.g., rotated 90 degrees or at other orientations) and the spatially relative descriptors used herein interpreted accordingly.

Exemplary embodiments are described herein with reference to cross-sectional illustrations that are schematic illustrations of idealized exemplary embodiments (and intermediate structures). As such, variations from the shapes of the illustrations as a result, for example, of manufacturing techniques and/or tolerances, are to be expected. Thus, exemplary embodiments should not be construed as limited to the particular shapes of regions illustrated herein, but are to include deviations in shapes that result, for example, from manufacturing.

Although a case for use with a mobile telephone is described herein, cases for other mobile electronic devices are contemplated to be within the scope of this invention. For example, cases that are within the scope of this invention are cases that may be used with, but not limited to, a smart phone, tablet, laptop computer, or other similar mobile communication devices. Various aspects of the inventive concepts will be described more fully hereinafter with reference to the accompanying drawings, in which some exemplary embodiments are shown. The present inventive concept may, however, be embodied in many different forms and should not be construed as limited to the exemplary embodiments set forth herein.

It will be understood that, although the terms first, second, etc. are be used herein to describe various elements, these elements should not be limited by these terms. These terms are used to distinguish one element from another, but not to imply a required sequence of elements. For example, a first element can be termed a second element, and, similarly, a second element can be termed a first element, without departing from the scope of the present invention. As used herein, the term “and/or” includes any and all combinations of one or more of the associated listed items.

It also will be understood that when an element is referred to as being “on”, “in communication with”, or “connected” or “coupled” to another element, it can be directly on or connected or coupled to the other element or intervening elements can be present. In contrast, when an element is referred to as being “directly on” or “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

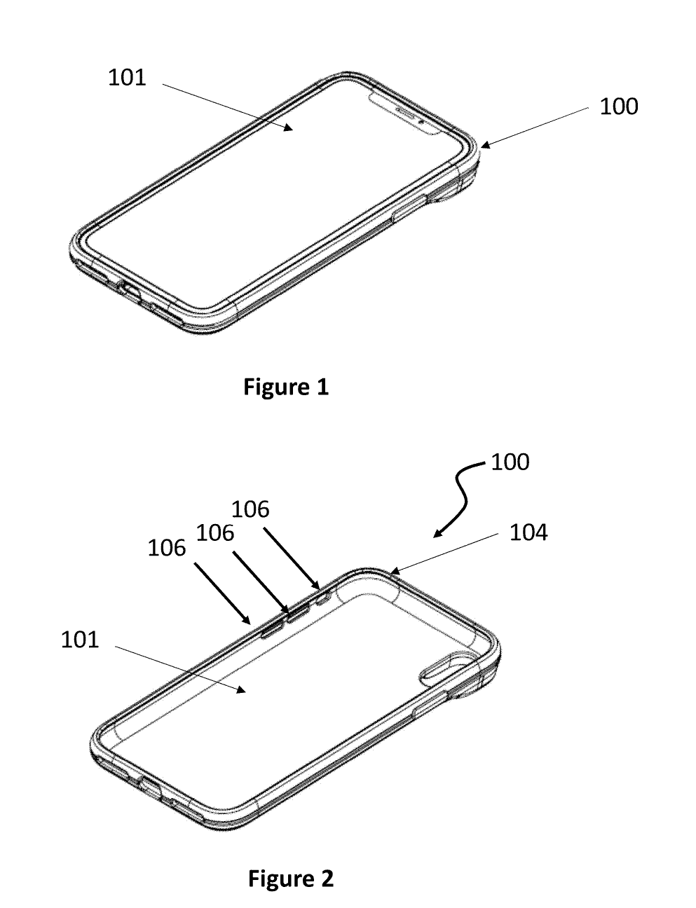

FIG. 1 depicts a mobile telephone case 100 in the environment in which it would ordinarily be used. As shown, mobile telephone case 100 may be used to encase a mobile device, such as a mobile telephone 101. Mobile telephone case 100 is preferably configured to cradle mobile telephone 101 on all sides and the rear. Mobile telephone case 100 may enclose mobile telephone 101 on all sides and the rear or back side of mobile telephone 101. For example, mobile telephone case 100 may be configured to securely hold mobile telephone 101 therein. In one exemplary embodiment, mobile telephone case 100 may enclose mobile telephone 101 such that front of mobile telephone 101 is exposed or accessible to the user. In this aspect, mobile telephone case 100 may removably hold mobile telephone 101 in similar to conventional mobile telephone cases. That is, mobile telephone case may substantially encase mobile telephone 101, but leave the front of the phone exposed. In one exemplary embodiment, mobile telephone case 100 may be comprised of similar material as is found in conventional mobile telephone cases.

As shown in FIG. 2, mobile telephone case 100 may include a first surface 102 for receiving and supporting mobile telephone 101 thereon. That is, when mobile telephone 101 is included in mobile telephone case 100, is a rear portion of mobile telephone 101 may rest on first surface 102. In one exemplary embodiment, first surface 102 may be planar. In another exemplary embodiment, first surface 102 may be configured to fit closely to the perimeter shape of mobile telephone 101. By “closely” what is meant is that the rear portion of mobile telephone 101 may be placed in abutment with first surface 102.

Mobile telephone case 100 may further include a side wall 104 in communication with the outer edge of first surface 102. Side wall 104 may be configured to contain mobile telephone 101 within mobile phone case 101. Side wall 104 may be further configured to ensure mobile telephone 101 remains removably contacted with first surface 102. In this way, the side edges of mobile telephone 101 are placed in abutment with side wall 104.

Many mobile telephones include control buttons, such as the on/off button, or the volume up and down buttons, which may be positioned around a mobile telephone outer edge. Mobile telephone case 100 may include apertures 106 for allowing the user access to the control buttons. In one exemplary embodiment, apertures 106 may appear in side wall 104 in locations that correspond to the locations of control buttons on mobile telephone 101. In another exemplary embodiment, mobile telephone case 100 may include false buttons 106 in side wall 104, which indicate to the user the location of the mobile telephone control buttons.

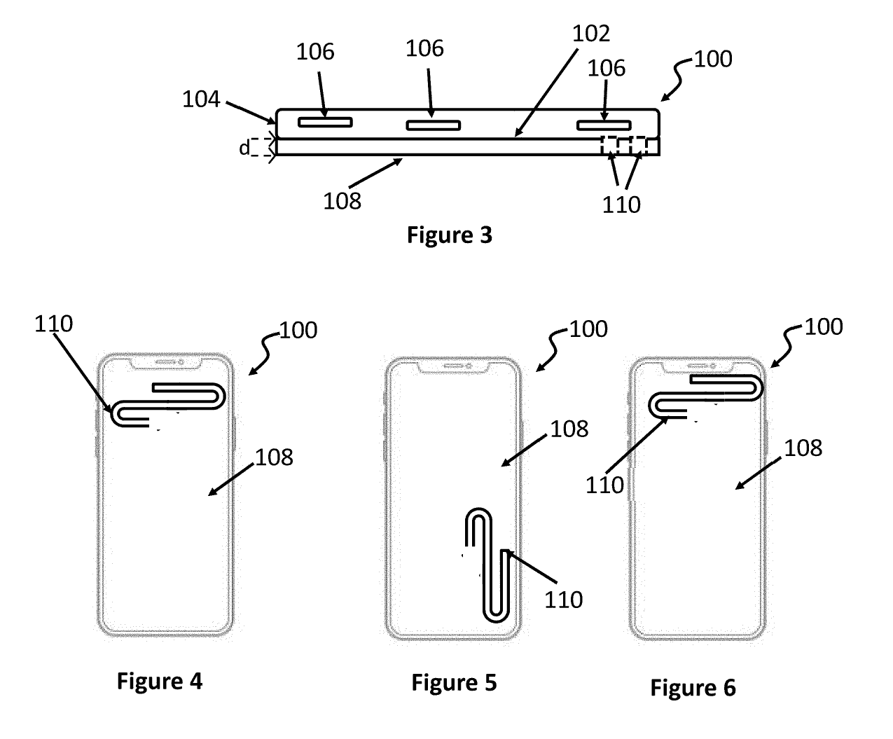

FIG. 3 depicts a side view of mobile telephone case 100 in accordance with the present invention. As shown, mobile telephone case 100 further includes a second surface 108 formed below first surface 102. In one exemplary embodiment, second surface 108 may be formed adjacent to first surface 102. In one exemplary embodiment, second surface 108 is separated from first surface 102 by a distance d. As used herein, the distance, d, between first surface 102 and second surface 104 may be described as the thickness of the rear portion of mobile telephone case 101. Specifically, the thickness of the rear portion represents the mobile telephone case 100 material that exists between first surface 102 and second surface 108.

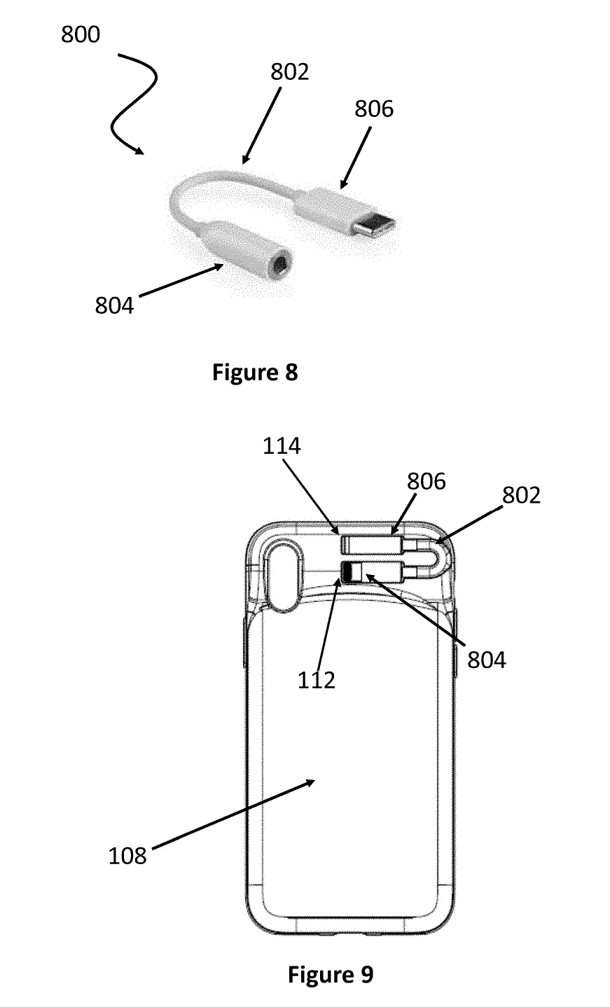

As noted, the user may desire to connect mobile telephone 101 to a third distinct device using for example an auxiliary cable. With brief reference to FIG. 8, what is depicted is an exemplary prior auxiliary cable 800 that may be useful with this invention. As shown, auxiliary cable 800 may be electrical in nature. For example, auxiliary cable 800 may include a wire cable 802 and a first electrical connector 804 for connecting to mobile telephone 101, and also a second electrical connector 806 for connecting to a third distinct device (not shown). It should be noted, that first electrical connector 804 may be of the same size and shape as second connector 806. Alternatively, first electrical connector 804 may be of a different size and shape as second connector 806. Additionally, auxiliary cable 800 may have a width, w, calculated at its widest point when first electrical connector 804 and second electrical connector 806 are lying in the same plane. For example, the widest point of auxiliary cable 800, w, may be the width of first connector 804. Alternatively, the widest point of auxiliary cable 800, w, may be the width of second connector 806. Further still, the widest point of auxiliary cable 800, w, may be the width of the wire cable 802.

With return reference to FIG. 4, what is depicted is a recess 110 formed in second surface 106. By “formed in” what may be meant is that recess 110 may formed as a depression in second surface 108. In one embodiment, recess 110 may be formed at least width of auxiliary cable 800. In another exemplary embodiment, recess 110 may be formed as a concave formation relative to second surface 108. In yet another exemplary embodiment, recess 110 may be formed to a depth substantially equal to the width, w, of auxiliary cable 800.

Conventional auxiliary cables that are useful with this invention may be malleable such that they may be curved around or twisted for easy storage. In such a case, recess 110 may be formed to accommodate the curved or twisted shape of auxiliary cable 800. In addition, it should be noted that recess 110 may be located in the second surface 108 at any location therein. For example, as shown in FIG. 4, recess 110 is located within an upper perimeter of second surface 108. FIG. 5 depicts recess 110 in a lower left portion of second surface 108. Further still, as shown in FIG. 6, recess 110 may be substantially located on second surface 108 wherein the recess includes a portion of side wall 104. More particularly, recess 110 may be formed such that side wall 104 is removed in the formation of recess 110 to accommodate auxiliary cable 800.

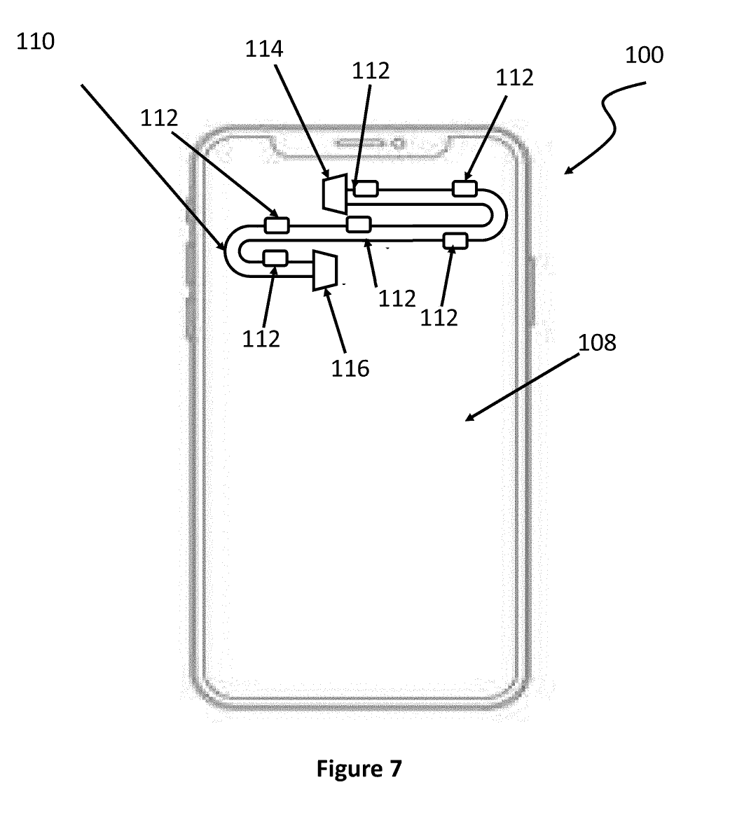

As noted, in some instances, first electrical connector 804 may be of a different shape than second electrical connector 806; or first electrical connector 804 may have the same shape as second electrical connector 806. In such an instance, recess 110 may be formed to receive first electrical connector 804 according to its shape. As shown in FIG. 7, recess 110 may include a recess first end 112 formed to receive first electrical connector 804 therein. That is, recess first end 112 may be formed as a molded cavity in the shape of first electrical connector 804. Similarly, recess 110 may be formed to receive second electrical connector 806 according to its shape. As shown in FIG. 7, recess 110 may include a recess second end 114 formed to receive second electrical connector 804 therein. That is, recess first end 112 may be formed as a molded cavity in the shape of first connector 804.

As noted, according to the invention, auxiliary cable 800 may be removably held within recess 110. That is, the user may store auxiliary cable 800 within recess 110 when not in use, and may remove auxiliary cable 800 from recess 110 when the user desires to use the cable. To facilitate this operation, second surface 108 may include grasping projections 112 configured to overhand a portion of recess 110. In one exemplary embodiment, second surface 108 may include one or multiple grasping projections 112.

In another exemplary embodiment, grasping projections 112 may be formed on the edge of recess 110. In such embodiment grasping projections 112 may be configured to overhang a portion of recess 110. In one exemplary embodiment, recess 110 may include one or multiple grasping projections 112. In yet another exemplary embodiment, grasping projections may formed of the same material as recess 110.

FIG. 9 depicts the present invention in use. As shown, auxiliary cable 800 is removably affixed to second surface 108. Auxiliary cable 800 in shown positioned within recess 110. First electrical end 804 is positioned within recess first end 114. Additionally, second electrical end 806 is positioned within recess second end 116.

Although the present invention and its advantages have been described in detail, it should be understood that various changes, substitutions and alterations can be made to the embodiments described herein without departing from the scope of the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. A case for a mobile terminal, the case comprising:
a. A first surface having a thickness, wherein the first surface comprises, a top surface for receiving a mobile terminal thereon, a bottom surface positioned opposite the top surface, wherein the top surface is separated from the bottom surface by said thickness, wherein the bottom surface comprises a recess formed therein, wherein the recess is formed at a depth less than the thickness, and wherein the recess is configured to receive an auxiliary cable therein.

2. A case according to claim 1, wherein the mobile terminal includes a perimeter shape, wherein the first surface has a perimeter shape substantially equal to perimeter shaper of the mobile terminal.

3. A case according to claim 1, wherein the recess is configured to receive substantially all of the auxiliary cable therein.

4. A case according to claim 2, wherein the recess is configured to hold the auxiliary cable removably affixed therein.

5. A case according to claim 4, wherein the recess includes a first grasping projection for holding the auxiliary cable removably affixed therein.
